(19) United States
(12) Patent Application Publication
(10) Pub. No.: US 2012/0318969 A1
(43) Pub. Date: Dec. 20, 2012

(54) METHOD FOR THE DIFFERENTIATION OF ALTERNATIVE SOURCES OF NAPHTHENIC ACIDS

(75) Inventors: Steven J. ROWLAND, Plymouth (GB); Charles E. West, Plymouth (GB); Alan G. Scarlett, Plymouth (GB); David Jones, Plymouth (GB)

(73) Assignee: UNIVERSITY OF PLYMOUTH, Plymouth (GB)

(21) Appl. No.: 13/160,367

(22) Filed: Jun. 14, 2011

(51) Int. Cl. H01J 49/26

(52) U.S. Cl. 250/282

(57) ABSTRACT

A method for determining naphthenic acids derived from different sources, in particular oil sands process water by identifying particular tricyclic and pentacyclic diamondoid acids in a sample and measuring the concentration of the acids to provide a distinctive profile for a given source.

### STATEMENT REGARDING FEDERALLY SPONSORED RESEARCH OR DEVELOPMENT

Not applicable.

### BACKGROUND

1. Field of the Disclosure

The present disclosure relates to a method for the differentiation of alternative sources of naphthenic acids, particularly but not exclusively the differentiation of naphthenic acids from natural oil sands and oil sands process water.

2. Background of the Disclosure

Oil sands are large natural deposits containing bitumen, a viscous form of petroleum. The process used for the extraction of bitumen from these sands generally uses substantial amounts of water resulting in a corresponding amount of process water being produced which is stored in large lagoons called tailing ponds. Concerns have been raised about the impact of potentially toxic, acid extractable organic matter known as naphthenic acids (NA) that are present in these tailing ponds. Such matter has been found to be toxic to fish, trees, birds and plankton.

It is known that toxic action is often structure-specific. However, prior to recent research by the present inventors, no individual naphthenic acid had been identified in oil sands process water (OSPW), despite decades of research. It would be desirable to be able to differentiate between NAs emanating from OSPW as well as from other sources, such as natural oil sands, offshore oil production platforms and other waste sources, such as wear of automobile tyres in which naphthenate salts are used to bond steel to rubber and the disposal and weathering of certain naphthenic acids-based biocides and fungicides.

It is desirable to be able to monitor the potential leaching of NA from these tailing ponds into surface waters and to be able to differentiate between leakage from natural oil sands and leakage from tailing ponds.

### BRIEF SUMMARY

A method of differentiating naphthenic acids (methyl esters) from oil sands process waters and alternative sources. In one instance the method comprises, analysing the naphthenic acid content from a sample obtained from an unknown source to identify any diamondoid acids selected from the group consisting of a tricyclic (I) or pentacylic (II) carboxylic acids, measuring the concentration of any diamondoid acids identified, plotting the ratios of the concentrations of said acids to provide a distinctive profile of diamondoid acids for the sample and comparing the sample profile with profiles for a selection of known sources to determine the source of the naphthenic acids.

The foregoing has outlined broadly the technical features and advantages of the disclosure made herein, in order that the detailed description that follows may be better understood. Additional features and advantages of the disclosure will be described hereinafter to form the claimed subject matter.

### DESCRIPTION OF THE FIGURES

The present disclosure may be better understood, and its numerous objects, features, and advantages made apparent to those skilled in the art by reference the accompanying figures.

FIGS. 1A to 1H are the structures of diamondoid acids identified in oil sands process water;

FIGS. 2A to 2C are examples of mass spectra of methyl esters of tricyclic acids identified in OSPW compared with the mass spectra of purchased reference acids (methyl esters);

FIG. 3 is a total ion current chromatogram of OSPW naphthenic acids (methyl esters) examined by GC×GC/ToF-MS illustrating high chromatographic resolution by GC×GC compared with GC/MS (white line on black background);

FIGS. 4A to 4F are examples of mass spectra of methyl esters of pentacyclic acids positively identified in OSPW NA by comparison of the spectra and GC×GC retention times with those of reference acids (methyl esters); and

FIG. 5 is a plot of ratios of chromatographic volumes for selected compounds within commercial NA preparations A and B to illustrate how the distinctive profiles differentiate between different sources using the method of the present disclosure.

The use of the same reference symbols in multiple figures, different figures, or in different embodiments may indicate similar or identical items as described here. Referring to the figures in general, it should be understood that the illustrations are for the purpose of describing a particular embodiment of the present disclosure and are not intended to limit the scope of the disclosure thereto.

### DETAILED DESCRIPTION

Overview:

It is an aim of the present disclosure to provide a method for the differentiation of alternative sources of NAs, particularly but not exclusively, the differentiation of NAs from natural oil sands and OSPW. Accordingly, the present disclosure provides a method for differentiating between alternative sources of naphthenic acids, the method comprising the steps of:

(a) analysing the naphthenic acid content from a sample obtained from an unknown source to identify any diamondoid acids selected from the group consisting of a tricyclic (I) or pentacylic (II) carboxylic acid having at least one of the general formulae given below:

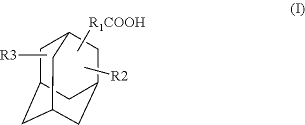

where each of R₁, R₂ and R₃ are either absent or present, R₁ comprises an alkylene group having 1 to 5 carbon atoms and R₂ and R₃ each comprise an alkyl group having 1 to 5 carbon atoms, being the same or different; and

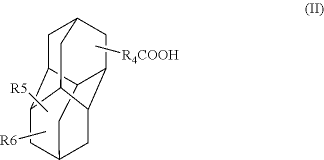

where each of R₄, R₅ and R₆ are either absent or present, R₄ comprises an alkylene group having 1 to 5 carbon atoms and R₅ and R₆ each comprise an alkyl group having 1 to 5 carbon atoms, being the same or different;
(b) measuring the concentration of any diamondoid acids identified in step (a);
(c) plotting the ratios of the concentrations of said acids to provide a distinctive profile of diamondoid acids for the sample: and
(d) comparing the profile with profiles for a selection of known sources to determine the source of the naphthenic acids.

Preferably, R₁ and R₃ are either a methylene or methyl group respectively or absent.

Preferably, R₂ is either a methyl or ethyl group or absent.

Preferably, R₄, R₅ and R₆ are either absent or a methylene or methyl group.

In certain instances, OSPW contains at least one of the carboxylic acids falling within either the general formula (I) or (II) described above. Furthermore, due to the unique distribution of these acids in different sources as a result of, for example, different biodegradation processes that can occur at a particular source, the distribution of these acids may be used to compare and contrast naphthenic acids mixtures emanating from different sources, including but not limited to commercial NAs preparations, offshore oil production platforms, oil sands process waters (OSPWs), waste, wear of automobile tyres, the disposal and weathering of certain NA-based biocides and fungicides, and other wastes without limitation

The concentration of at least two specific naphthenic acids of the general formulas (I) or (II) above found in a sample are measured and the ratios of these concentrations plotted to provide a distinctive profile for a given naphthenic acid source. In instances, the diamondoid acids are identified using two-dimensional comprehensive gas chromatography coupled with time of flight-mass spectrometry (GC×GC/ToF-MS). In embodiments, the acids of a sample are first extracted into an organic solvent by any conventional means. Further, in embodiments that acids may be derivatised prior to carrying out the GC×GC/ToF-MS, for example by refluxing with BF₃-methanol or BF₃-trideuterated methanol. Alternatively, the distribution of these acids and their derivatives may be monitored by techniques such as liquid chromatography-mass spectrometry of amides (Smith and Rowland, “A derivatisation and liquid chromatography/electrospray ionisation multistage mass spectrometry method for the characterisation of NAs”. Rapid Commun. Mass Spectrom. 2008, 22, 3909-3927) or other means based on chromatography and mass spectrometry, such as those reviewed by Headley et al (“Mass spectrometric characterization of NAs in environmental samples: a review”. Mass Spec. Rev. 2009, 28, 121-134).

In an exemplary embodiment of the present disclosure, the concentrations of adamantane-1-carboxylic acid, adamantane-2-carboxylic acid, adamantane-1-ethanoic acid and 3-methyladamantane-1-ethanoic acid are measured and the ratios of their concentrations plotted to provide a distinctive profile of a given NA source. In further embodiments, the concentrations of other diamondoid acids may be used, such as the pentacyclic acids and di-acids, in particular diamantane, methyl and dimethyldiamantane, diamantane ethanoic acid, methyl and dimethyldiamantane ethanoic and higher alkylated diamantane acids.

Further, in embodiments the method employs the use of a co-chromatographed known concentration of a tri-deuterated methyl esters of adamantane-1-carboxylic acid and 3-methyladamantane-1-ethanoic acid, compared to which the responses of the diamondoid acid in a particular source can be measured. It is may be understood by a skilled artisan that the profiles may be compared with commercially available synthetic mixtures of NAs and individual diamondoid acids, such as adamantane-1-carboxylic, adamantane-1-ethanoic, 3-methyladamantane-1-ethanoic and 3-ethyl-adamantane-1-carboxylic acids for calibration and confirmation purposes. These can be purchased from commercial suppliers such as Sigma (Poole, U.K.).

The present disclosure will now be further illustrated, by way of the following Examples.

### EXAMPLES

Example 1 investigates the identification of tricyclic diamondoid acids in OSPW.

Example 2 investigates the identification of tetra- and pentacyclic NAs in OSPW.

Example 3 describes the plotting of a distinctive profile for the concentration of particular diamondoid acids from alternative naphthenic acid sources.

The examples are in accordance with the method of the present disclosure, and with reference to the accompanying figures in which Examples 1 and 2 below describe how the methods set out in our recent publications may be used for the identification of specific tricyclic and pentacylic diamondoid acids in OSPW (Rowland, S. J., Scarlett, A. G., Jones, D., West, C. E. and Frank, R. A. (2011) Diamonds in the rough: Identification of individual naphthenic acids in oil sands process water. Environmental Science & Technology 45, 3154-3159 and Rowland et al., (2011) Identification of individual tetra- and pentacyclic naphthenic acids in oil sands process water by comprehensive two-dimensional gas chromatography-mass spectrometry. Rapid Communications in Mass Spectrometry 25, 1198-1204). As demonstrated herein, the identifications are far from simple. Once identification has taken place, the ratio of the concentrations of the diamondoid acids in the sample can be measured and used to differentiate between different sources of NAs according to the method of the present disclosure as illustrated in Example 3.

### Example 1

### Identification of Tricyclic Diamondoid Acids in Oil Sands Process Water

Adamantane-1-carboxylic and 3-ethyl-adamantane-1-carboxylic acid were purchased from Sigma (UK) and the OSPW NA was obtained from a previous study of the inventors. Acids were derivatized by refluxing with BF₃-methanol.

Two-dimensional comprehensive gas chromatography-time-of-flight-mass spectrometry (GC×GC-ToF-MS) analyses were conducted using an Agilent 7890A gas chromatograph (Agilent Technologies, Wilmington, Del.) fitted with a Zoex ZX2 GC×GC cryogenic modulator (Houston, Tex., USA) interfaced with an Almsco Bench TOFdx time-of-flight-mass spectrometer (Almsco International, Llantrisant, Wales, UK) operated in positive ion electron ionization mode and calibrated with perfluorotributylamine. The scan speed was 50 Hz. The resolution of the mass spectrometer was 1000 at mass 1000. The first-dimension column was a 100% dimethyl polysiloxane 50 m×0.25 mm×0.40 μm VFI-MS (Varian, Palo Alto, USA) with an efficiency of 211700 theoretical plates (n-tridecane) and the second-dimension column was a 50% phenyl polysilphenylene siloxane 1.5 m×0.1 mm×0.1 mm×0.1 μm BPX50 (SGE, Melbourne, Australia) with an efficiency of 5121 theoretical plates per meter (biphenyl). Thus the product efficiency of the GC×GC system was calculated as approximately 1.6 billion theoretical plates. Helium was used as carrier gas, and the flow was kept constant at 0.7 mL min. Samples (1 μL) were injected at 280° C. splitless. The oven was programmed from 40° C. (held for 1 min) and then heated to 300 at 2° C. min and then at 10° C. min to 320° C. (held for 10 min). The modulation period was 5 s. The mass spectrometer transfer line temperature was 280° C. and ion source temperature 300° C. Data processing was conducted using GC Image v2.1 (Zoex, Houston, Tex., USA).

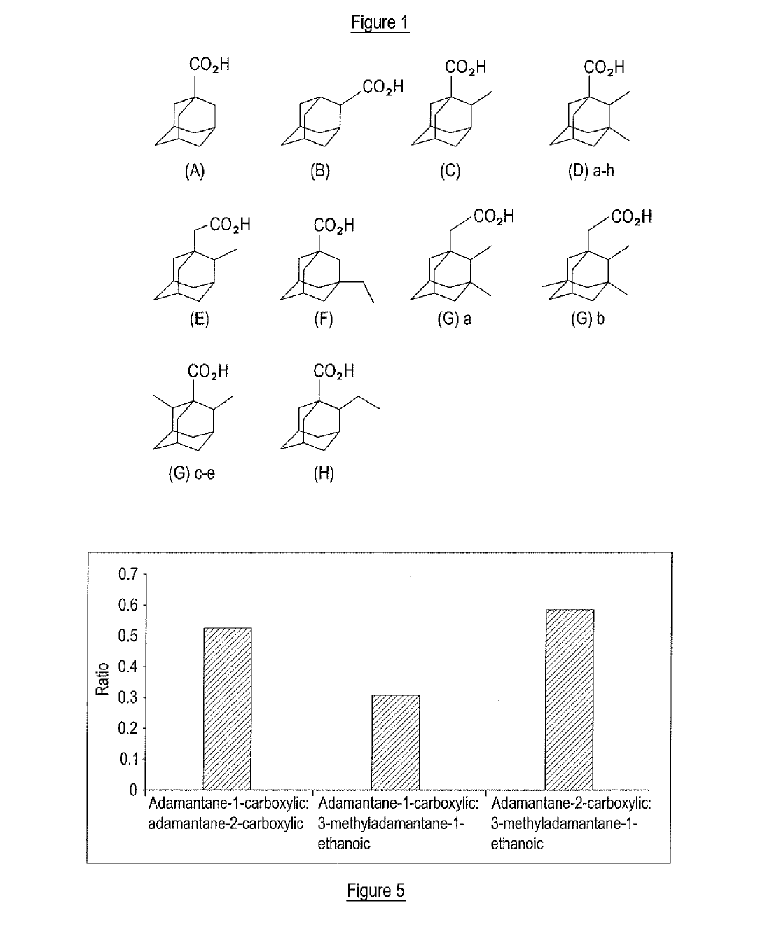

A sample of the methyl ester derivatives of OSPW NA were examined by GC×GC-ToF-MS. The OSPW was collected en route to storage in an in-pit settling basin. By conventional GC-MS the OSPW NA were almost completely unresolved. In contrast GC×GC resolution under the optimized conditions was very high allowing electron ionisation mass spectra containing molecular and fragment ions of many individual acids to be obtained. FIG. 1 of the accompanying drawings illustrates the structure of some of the acids identified. The normal background of ions which is caused by the thermal desorption of the GC stationary phases (so-called “bleed” ions) was also well separated by GC×GC from ions produced by ionization of the acid methyl esters, which further improved the quality of the mass spectra of the unknown esters. Thus, due to these factors and the over 1.6 billion theoretical plates calculated for the combined GC×GC columns, the mass spectra obtained for many of the OSPW acids (methyl esters) were essentially those of individual compounds, as was also shown by the close similarities with the spectra of some relevant authentic acids (methyl esters).

The mass spectra contained clear molecular ions which showed that the OSPW NA comprised mainly C₁₁₋₁₉ bi-to pentacyclic acids, fitting the formula CₙH2_{n+z}O₂. Although numerous other compounds have been suggested to be present in OSPW NA (Grewer et al., “Naphthenic acids and other acid-extractables in water samples from Alberta: What is being measured?” Sci. Total Environ. 2010. 408, 5997-6010), we detected overwhelmingly NA (methyl esters) fitting the above formula, with only a few minor hydrocarbons and other constituents. Unrefined oil sands bitumen has been reported previously to contain 90% tricyclic acids, and electrospray mass spectra of OSPW NA have routinely shown that tricyclic and bicyclic acids are the major components (Frank et al., “Toxicity Assessment of collected fractions from an extracted NA mixture.” Chemosphere 2008 72, 1309-1314 and Headley et al., “Mass spectrometric characterization of NAs in environmental samples: a review.” Mass. Spec. Rev. 2009, 43, 266-271); therefore, this study concentrated on identifying the tricyclic compounds.

The mass spectra of the tricyclic OSPW acids did not match those in mass spectral libraries or in any published literature available. However, the inventors were able to identify several of them by interpreting the spectra from first principles, then obtaining as many reference acids as were available, esterifying these, and obtaining the spectra of the methyl esters by GC×GC-ToF-MS for comparison with the spectra of the GC×GC retention times of the unknowns.

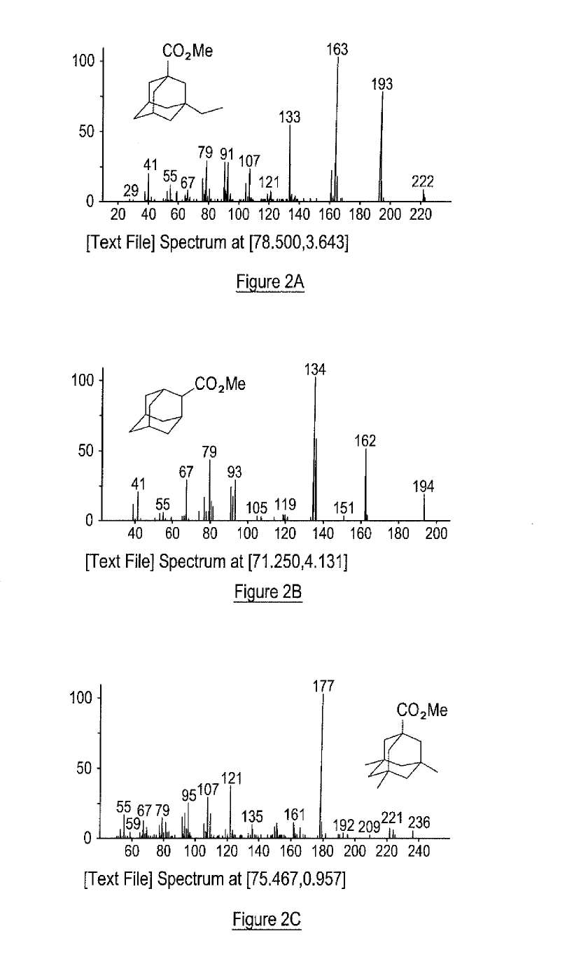

The results thus far show that the OSPW comprises an extensive series of diamondoid tricyclic acids (as shown in FIG. 1). Thus adamantane-1-carboxylic acid (FIG. 1A) was identified by comparison to the mass spectrum and GC×GC retention times with that of a reference sample. The spectrum contained a minor molecular ion (m/z 194) and was dominated by a base peak ion m/z 135 due, we suggest, to fragmentation and loss of the methylated carboxyl group. The corresponding adamantane-2-carboxylic acid (FIG. 1B) was also identified. This isomer is known to have a later retention time on the first apolar GC column than the 1-isomer, and the mass spectrum of the unknown and of a synthetic acid (FIG. 2A) was also characterized by a molecular ion (M⁺ 194) and major fragment ions due to loss of methanol (m/z 162), typical of methyl esters and again, loss of the methylated carboxy group (m/z 135). However, a noteworthy difference to the spectrum of the 1-isomer in which the carboxy group is substituted at a quaternary center (C-1), was the base peak ion at m/z 134 in the putative 2-isomer. Formation of this ion was interpreted as being due to loss of the methylated carboxy group followed by H-transfer at the tertiary center to form an even mass alkenyl ion (m/z 134). This dominance of an even mass base peak ion might prove to be a useful feature for distinguishing isomers of diamondoid acids substituted at tertiary centers (e.g., C-1) compared with those substituted at quaternary centers (e.g., C-2). This was confirmed by the synthesis of a sample of the methyl ester of adamantane-2-carboxylic acid (FIG. 2A).

Also identified was the methyl ester of 3-ethyladamantane-1-carboxylic acid (FIG. 1F) by comparison of the spectrum with that of a reference sample. The mass spectrum, like that of a reference sample (FIG. 2B) contained a molecular ion m/z 222 and ions due to loss of the ethyl group (m/z 193) and the methylated carboxy group (m/z 163).

In addition, also identified were numerous methyl, dimethyl and ethyladamantane carboxylic acids and adamantane ethanoic acid isomers by interpretation of the mass spectra from first principles and in some cases by the purchase of additional reference acids. The spectra of the methyl esters of the methyl adamantane carboxylic acids were characterized by molecular ions (m/z 208) and were dominated by a base peak ion m/z 149 due to fragmentation and loss of the methylated carboxy group; those of the esters of the dimethyladamantane carboxylic acids (numerous isomers were present, separated by GC×GC) by a molecular ion (m/z 222), dominated by a base peak ion m/z 163; those of the esters of the trimethyladamantane carboxylic acids (numerous isomers were present, separated by GC×GC) by a molecular ion (m/z 222), dominated by a base peak ion m/z 163, one identical to a spectrum of 3,5,7-trimethyl-adamantane-1-carboxylic acid (methyl ester; FIG. 2C) purchased from Maybridge Chemicals, Tintagel, Cornwall. (Common components such as phthalate esters, which also have dominant m/z 149 ions in their mass spectra, were well separated from such NA by GC×GC as they are esters of aromatic acids, the aromaticity resulting in good separation from the methyl esters of the NA on the second, more polar, GC phase. Thus the NA were easily differentiated from common laboratory contaminants, such as phthalates).

Other isomers of ethyl adamantane carboxylic acids were identified by the presence of the latter ions in different relative abundances. Adamantane ethanoic acids were also present; for example, the spectrum of a methyladamantane ethanoic acid contained in a molecular ion (m/z 222) consistent with the methyl ester of a C₁₃ tricyclic acid, but the base peak ion was m/z 149, indicative of a methyl substituted (C₁₁) tricyclic core, rather than the m/z 163 characteristic of the dimemthyl C₁₂ adamantane core. This formation of ethanoic acids is consistent with an origin from biodegradation of adamantane hydrocarbons (Smith and Rowland, supra).

The distributions of multiple series of adamantane carboxylic acids (methyl esters) may be displayed by selected ion mass chromatography of key ions in the spectra. Thus GC×GC-ToF-MS allows the distributions of multiple individual acids in different OSPWs or OSPW and environmental samples to be compared routinely.

It is proposed that most, if not all, of the diamondoid acids are biotransformation products of methyl, dimethyl, ethyl, and ethyl-methyladamantane hydrocarbons. Although an origin from oxidation during oil sands processing may also be feasible since the hydrocarbons are widely reported in crude oils including in Western Canada oils, laboratory and field studies have shown that both adamantane and the methyl adamantane hydrocarbons are indeed slightly biotransformed by some bacteria. However, the acidic products have never been identified previously.

The discovery of adamantane diamondoid acids in OSPW NA allows identification not only of the first specific structural class of NA in oil sands, but also of some of the first individual isomers of oil sands NA to be made, including members of the abundant tricyclic constituents.

### Example 2

### Identification of Individual Tetra- and Pentacyclic Naphthenic Acids in Oil Sands Process Water

Synthetic diamantane-1-, diamantane 3- and diamantane-4-carboxylic acids and diamantane-1,4-, 1,6- and 4,9-diacids were obtained from a third party. The OSPW NA was obtained from a previous study of the inventors. The acids were derivatised by refluxing with BF₃-methanol.

Comprehensive two-dimensional gas chromatography/time-of-flight mass spectrometry (GC×GC/ToF-MS) analyses were conducted as described in Example 1.

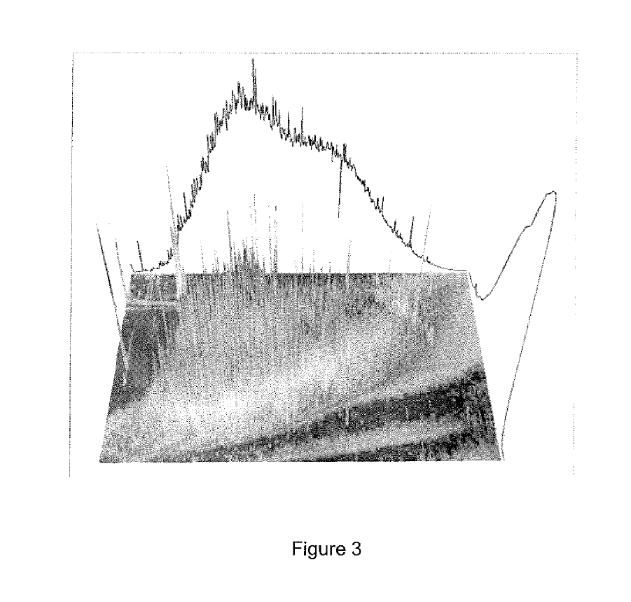

Examination, by GC×GC/ToF-MS, of a sample of the methyl ester derivatives of OSPW NA resulted in a highly resolved chromatogram (FIG. 3) allowing electron ionisation (EI) mass spectra containing molecular and fragment ions of many individual tetra- and pentacyclic acids to be obtained.

The mass spectra of the acids did not match those available in mass spectral libraries, or in any published literature of which the inventors were aware. However, many were identified by interpretation of the spectra from first principles, and in two cases by obtaining reference diamantane acids, esterifying these and obtaining the mass spectra and GC×GC retention times of the methyl esters. Some isomers were also ruled out by examination of further reference acids.

Previous reports have suggested that whilst adamantane and some lower alkyladamantanes are slightly susceptible to biodegradation, the corresponding pentacyclic diamantane nanodiamonds are resistant to biodegradation (K. Grice et al., “Diamondoid hydrocarbon ratios as indicators of biodegradation in Australian crude oils.” Org. Geochem. 2000, 31, 67 and Z. Wang et al., “Forensic fingerprinting of diamondoids for correlation and differentiation of spilled oil and petroleum products. Environ. Sci. Technol. 2006, 40, 5636). However, the present results suggest that the extent of the biodegradation of some of the organic matter from which the OSPW NA originate exceeds some conventional biodegradation scales since, in addition to the tricyclic acids, pentacyclic diamondoid acids have now been identified.

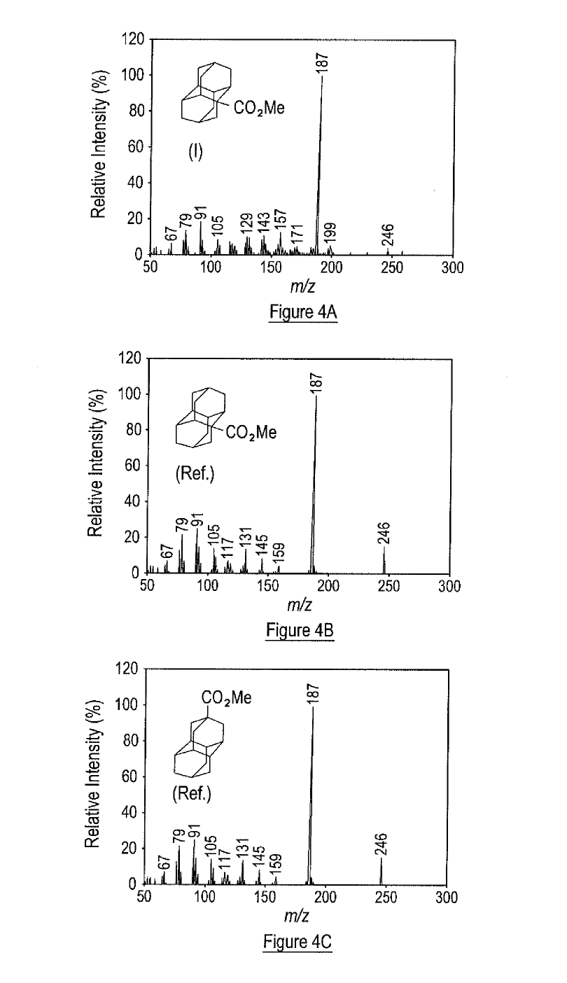

The methyl ester of diamantane-1-carboxylic acid (I, FIG. 4A) was identified by interpretation of the mass spectrum and by comparing this with the mass spectra and GC×GC retention times of reference samples of each of the three possible (1-, 3- and 4-) isomers (FIGS. 4(B), 4(C) and 4(E)). The suspected molecular ion M⁺, m/z 246) was observed in the spectrum of unknown I (FIG. 4(A)), along with a major fragment ion (m/z 187, base peak) assigned to loss of the methylated carboxy substituent from a quaternary centre. Many of the same ions were present in the spectrum of synthetic diamantane-1-carboxylic acid (methyl ester; FIG. 4 (B)), although the molecular ion was more abundant in the latter and some other ions in the spectra of the unknown and the reference acid were different. This difference could be due to some residual co-elution of other compounds with the OSPW acid (I) although the retention times (GC×GC/MS) of the unknown were the same as those of the reference acid (within 0.01 mm in first-dimension GC). The mass spectrum of the unknown was also very similar to that of diamantane-4-carboxylic acid (methyl ester, FIG. 4 (C)) but the GC retention time of the latter in the second dimension was very slightly less than that of the unknown. Thus, acid I was identified as diamantane-1 carboxylic acid (methyl ester), although both the 1- and the 4-isomers could be present.

The spectrum of the methyl ester of a component assigned as a further isomeric diamantane carboxylic acid (II) was also obtained in the OSPW acids (FIG. 4 (D)). The latter was characterised by a molecular ion (m/z 246), an ion assigned to loss of methanol (m/z 214), and a base peak of m/z 186 rather than m/z 187. This change in the base peak was attributed to the differences between the ease of formation and subsequent stability of the secondary and tertiary carbocations at the medial and apical positions, respectively, with the secondary carbocation formed at C-3 leading to an alkenyl ion (m/z 186). This was further confirmed when the mass spectrum and GC×GC retention times of a reference sample of diamantane-3-carboxylic acid (methyl ester, FIG. 4 (E)) was examined. Thus, this compound was identified as diamantane-3-carboxylic acid (methyl ester).

The reference sample of diamantane-1-carboxylic acid also contained a small amount of an unknown component (FIG. 4F). Thus, the molecular ion (m/z 246) and an ion assigned to the loss of methanol (m/z 214) were present, in addition to the m/z 187 base peak (FIG. 4(F)). No similar component was present in the OSPW acids. As far as the inventors are aware, no mass spectra of the methyl esters of the diamantane carboxylic acids have been published previously.

Spectra consistent with some higher diamantane acid homologues were also obtained. For example, the methyldiamantane carboxylic acids (methyl esters, numerous isomers) were tentatively assigned from spectra containing the molecular ion (m/z 260) and base peak (m/z 201) due to loss of the methylated carboxy substituents. In one isomer, tentatively assigned as 3-methyldiamantane-4-carboxylic acid, a loss of 101 Da from the molecular ion (to form m/z 159) suggested the presence of a 3-methyl branched ester. A minor amount of diamantane ethanoic acid with a non-alkyl-substituted diamantyl core was tentatively assigned from the molecular ion (m/z 260) and base peak (m/z 187) formed by loss of the substituent. A dimethyldiamantane carboxylic acid was tentatively assigned from the molecular ion (m/z 274) and abundant ion at m/z 215 due to loss of the methylated carboxy substituents (56%); the base peak was at m/z 199, representing a loss of 75 Da from the molecular ion. This may be due to loss of the so-called McLafferty+1 fragment and it is suggested that this abundant ion may be indicative of disubstitution of one of the methyl groups and the methylated carboxy substituent, necessarily on one of the secondary positions. A methyldiamantane ethanoic acid was also identified from the molecular ion (m/z 274) and base peak m/z 201 formed by loss of the methylated carboxy substituent. A further methyldiamantane ethanoic acid was tentatively identified with the methylated carboxy substituent on a secondary carbon atom (i.e. C-3) due to the formation of an even-mass base peak (B⁺ 200) in place of the odd-mass ion (B⁺ 201) for the reasons discussed above. By similar arguments, the dimethyldiamantane ethanoic acids substituted in apical and secondary carbons, respectively, were also tentatively assigned (M⁺ 288, B⁺ m/z 215; IX, M⁺ 288, B^{+m/z} 214).

The foregoing acids can be rationalised as partial biotransformation products of methyl, dimethyl-, ethyl-, trimethyl-, ethylmethyl- and dimethylethyldiamantanes, although they may result from other oxidative processes. Methyl-, dimethyl- and ethyldiamantanes are known hydrocarbons in crude oils and condensates but trimethyl-, ethymethyl- and dimethylethyldiamantanes have not been reported, to our knowledge. Our data suggests that they may be found in the future. Also tentatively identified were other diamantane acids for which no known hydrocarbon precursors have been reported. A mass spectrum consistent with a diamantane butanoic acid was obtained. The ion (m/z 288) was accompanied by a base peak of m/z 187 consistent with a non-alkylated diamantane nuclear. However, it is suggested that the butanoic acid substituent originates from biotransformation of ter-butyl substituent; n-iso- and sec-butyl substituents are more easily oxidised by microbes and might be more easily further degraded. Also tentatively identified was a dimethyl-substituted analogue of the above diamantane butanoic acid (M⁺ 316, B⁺ 215), suggesting that higher alkylated diamantane homologues are present in the oils from which the OSPW NA were originally produced. Other branched alkanoate substituents were present in some diamantane acids. Thus, methyl- and dimethylpropanoic acids, derived, we suggest, from methyl-1-propyl- and dimethyl-1-propyldiamantanes, were tentatively identified from the molecular ions (M⁺ m/z 288 and 302) and the base peaks (B⁺, m/z 201 and 215). Methyl branched alkanoate-substituted cyclohexyl acids were shown previously to be resistant to microbial transformation, and we therefore considered the presence of such acids as further evidence of the extensive degradation of some of the organic matter from which the OSPW was derived.

Thus, numerous diamantane, methyl and dimethyl diamantane, diamantane ethanoic, methyl and dimethyl-diamantane ethanoic and higher alkylated diamantane acids were observed in OSPW NA, it is believed for the first time. The distributions of isomeric diamantane acids could be readily displayed by mass chromatography of selected ions.

Since such pentacyclic compounds have never previously been considered as components of OSPW, their toxicities are also unstudied. Synthetic methods exist for numerous of these compounds, so these should be re-synthesised, used to confirm the tentative assignments above and assayed for possible toxicological effects. No evidence was found for the biodegradation of triamantanes or tetramantanes, but traces of compounds tentatively identified as unaltered methyletetramantane hydrocarbons M⁺, M⁺-CH₃) were present. Pre-processing of the waste removes most hydrocarbons, however, so it is to be expected that the hydrocarbons will be minor constituents Likewise, diamantane dicarboxylic acids were not detected, using the spectra of the dimethyl esters of diamantane-1,6, -1-4 and -4-9, -diacid reference compounds as guides, all spectra were indistinguishable from one another), suggesting that further degradation of the mono-acids does not proceed by this route. However, the mass spectra of some of the tetracyclic acids in the OSPW were tentatively interpreted as being due the methyl esters of ring-opened diamantane and methyl-diamantanes (viz alkyltetracyclo[7.3.1.0^{2.7}0^{6.11}]tridecane-4-carboxylic acids).

The distributions of individual diamantane carboxylic acids (methyl esters) could be displayed by selected ion mass chromatography of key ions in the spectra. Thus, GC×GC/ToF-MS allows the distributions of multiple individual acids in different OSPW, or OSPW and environmental samples, to be compared routinely. Once suitable GC×GC/MS response calibrations have been constructed with reference acids, the quantities of these acids in OSPW NA can also be estimated and profiles plotted to provide an identification profile for a particular source of NAs, such as OSPW or otherwise.

### Example 3

### The Plotting of a Distinctive Profile for the Concentration of Particular Diamondoid Acids from Two Commercial Preparations of Naphthenic Acids (A and B)

A sample of naphthenic acids was derivatised by refluxing with BF₃-methanol (30 minutes). A solution of the derivatised mixture in hexane was injected into a two-dimensional comprehensive gas chromatography-time of flight-mass spectrometer as described above in relation to Example 1.

Mass chromatograms of ions at masses m/z 194+135 and m/z 194+134 were plotted, the results of which are shown in Tables 1 and 2 below, showing elution times and chromatographic volumes for three adamantane acids present in the two commercially prepared NAs respectively.

TABLE 1
Commercial Preparation A

| | 1^{st}elution | 2^{nd}elution | Integrated volume |
|---|---|---|---|
| Diamondoid acid | time/min | time/sec | (no units) |
| Adamantane-1-carboxylic acid | 35.25 | 2.67 | 132505 |
| Adamantane-2-carboxylic acid | 35.92 | 2.89 | 251006 |
| 3-methyladamantane-1- | 37.67 | 2.54 | 424525 |
| ethanoic acid. | | | |

TABLE 2
Commercial Preparation B

| | 1^{st}elution | 2^{nd}elution | Integrated volume |
|---|---|---|---|
| Diamondoid acid | time/min | time/sec | (no units) |
| Adamantane-1-carboxylic acid | Np | | |
| Adamantane-2-carboxylic acid | 35.92 | 2.87 | 355516 |
| 3-methyladamantane-1- | Np | | |
| ethanoic acid. | | | |

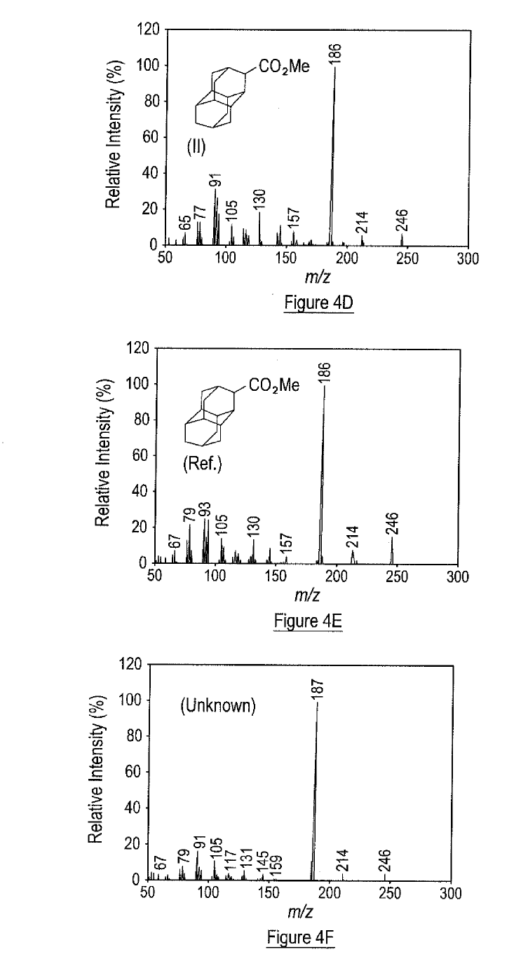

The areas due to chromatographic peaks with the retention times of authentic methyl esters of adamantane-1-carboxylic acid and adamantane-2-carboxylic acid were integrated and a ratio of the areas plotted (FIG. 5). As only adamantane-2-carboxylic acid is present in preparation B, all ratios=0 and thus the profile is entirely distinct to that of preparation A.

It is to be appreciated that the distinctive profiles of tricyclic and pentacyclic diamondoid acids contained within samples from other sources can be mapped and used to identify samples originating from that same source.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of broader terms such as “comprises”, “includes”, and “having” should be understood to provide support for narrower terms such as “consisting of”, “consisting essentially of”, and “comprised substantially of”. Accordingly, the scope of protection is not limited by the description set out above but is defined by the claims that follow, that scope including all equivalents of the subject matter of the claims. Each and every claim is incorporated as further disclosure into the specification, and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

1. A method for differentiating between alternative sources of naphthenic acids, the method comprising:
(a) analysing a naphthenic acid content from a sample obtained from an unknown source to identify any diamondoid acids selected from the group consisting of a tricyclic (I) or pentacylic (II) carboxylic acid having at least one of the general formulae given below: 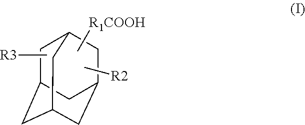
where each of R₁, R₂ and R₃ are either absent or present, R₁ comprises an alkylene group having 1 to 5 carbon atoms and R₂ and R₃ each comprise an alkyl group having 1 to 5 carbon atoms, being the same or different;
and 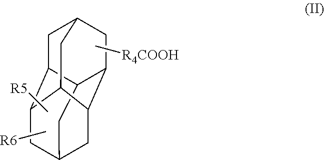
where each of R₄, R₅ and R₆ are either absent or present, R₄ is an alkylene group having 1 to 5 carbon atoms and R₅ and R₆ each comprise an alkyl group having 1 to 5 carbon atoms, being the same or different;
(b) measuring a concentration of said identified diamondoid acids;
(c) plotting ratios of the concentrations of said identified acids to provide a distinctive profile of diamondoid acids for the sample; and
(d) comparing the profile with a profile for a known source to determine a source of the naphthenic acid.

2. The method according to claim 1 wherein R₁ and R₃ are either a methylene or methyl group respectively, or absent.

3. The method according to claim 1 wherein R₂ is either a methyl or ethyl group or absent.

4. The method according to claim 1 wherein R₄, R₅ and R₆ are either absent or a methylene or methyl group.

5. The method according to claim 1 wherein the diamondoid acids are identified using two-dimensional comprehensive gas chromatography coupled with time of flight-mass spectrometry (GC×GC/ToF-MS).

6. The method according to claim 5 wherein the acids of a sample are derivatised prior to carrying out the GC×GC/ToF-MS.

7. The method according to claim 6 wherein the acids are derivatised by refluxing with BF₃-methanol or BF₃-trideuterated methanol.

8. The method according to claim 1 wherein the concentrations of at least two of adamantane-1-carboxylic acid, adamantane-2-carboxylic acid, adamantane-1-ethanoic acid and 3-methyladamantane-1-ethanoic acid are measured in the sample and the ratios of their concentrations plotted to provide a distinctive profile of a given NA source.

9. The method according to claim 1 wherein the concentrations of at least two of diamantane, methyl and dimethyl diamantane, diamantane ethanoic acid, methyl and dimethyldiamantane ethanoic and higher alkylated diamantane acids are measured in the sample and the ratios of their concentrations plotted to provide a distinctive profile of a given NA source.

10. The method according to claim 1 wherein the profile is compared with profiles for a selection of known sources to determine the source of the naphthenic acid.
